(19) United States
(12) Patent Application Publication
(10) Pub. No.: US 2026/0062160 A1
(43) Pub. Date: Mar. 5, 2026

(54) Sealing apparatus with a diameter variable type cartridge

(71) Applicant: Smart corporation Co., Ltd., Incheon (KR)

(72) Inventor: Ki Seok CHOI, Incheon (KR)

(21) Appl. No.: 19/256,166

(22) Filed: Jul. 1, 2025

(30) Foreign Application Priority Data
Sep. 2, 2024 (KR) 10-2024-0118696

(51) Int. Cl. B65B 7/16; B65G 47/91

(52) U.S. Cl. CPC B65B 7/164; B65G 47/91

(57) ABSTRACT

According to one embodiment of the present invention, disclosed is a cartridge that can be attached to a sealing apparatus for sealing a bottle and accommodates a plurality of stacked sealing sheets, which comprises: an annular-shaped rotating ring rotatably installed in the sealing apparatus; and a plurality of guide bars installed inside of the rotating ring and vertically arranged at a predetermined interval from each other along the circumference of the plurality of stacked sealing sheets, wherein the plurality of guide bars are configured to move simultaneously closer to a center of the rotating ring or to move simultaneously away from the center.

### TECHNICAL FIELD

The present invention relates to a sealing apparatus for sealing a bottle, and more specifically to a sealing apparatus equipped with a cartridge accommodating a plurality of sealing sheets stacked thereto.

### BACKGROUND TECHNOLOGY

In general, high-frequency sealing apparatuses for filling a bottle with contents and sealing an opening of the bottle with a sealing sheet such as aluminum foil, etc. by an induction sealing manner are widely used in the industry. A conventional high-frequency sealing apparatus is provided with a cartridge which accommodates a large quantity of vertically stacked sealing sheets, and takes the sealing sheets one by one out of the cartridge using a suction nozzle to convey it to the sealing unit, and then the sealing unit places the sealing sheet at an upper opening of the bottle, applies a high-frequency current to an induction coil, and heats the sealing sheet to seal the opening of the bottle.

However, since the size of the opening of the bottle varies depending on the size of the bottle, the size of the sealing sheet also varies accordingly. Thus, the size of the cartridge (that is, the diameter of the space of the cartridge for accommodating the sealing sheets) should also be changed. In this case, in the conventional sealing apparatus, the original cartridge attached to the sealing apparatus is replaced with another cartridge of a different size. However, not only is the replacement of the cartridge inconvenient, but various types of cartridges should also be prepared in advance according to the size of the sealing sheets, and thus inconvenient storage of cartridges and increased device costs would pose problems.

### CONTENTS OF INVENTION

### Problems to be Solved

The present invention aims to solve the problems above, and has an object to provide a diameter variable type cartridge capable of varying the diameter of the space for accommodating the sealing sheets as needed to eliminate the inconvenience that the cartridge should be replaced according to the size of the sealing sheet.

### Means for Solving the Problem

According to one embodiment of the present invention, disclosed is a cartridge that can be attached to a sealing apparatus for sealing a bottle and accommodates a plurality of stacked sealing sheets, which comprises: an annular-shaped rotating ring rotatably installed in the sealing apparatus; and a plurality of guide bars installed inside of the rotating ring and vertically arranged at a predetermined interval from each other along the circumference of the plurality of stacked sealing sheets, wherein the plurality of guide bars are configured to move simultaneously closer to a center of the rotating ring or to move simultaneously away from the center.

In one embodiment, each of the plurality of guide bars may comprise a protrusion plate having at least one horizontal locking protrusion at its bottom.

In one embodiment, the protrusion plate may comprise a plurality of locking protrusions with different protrusion lengths in the horizontal direction.

According to one embodiment of the present invention, disclosed is a sealing apparatus for sealing a bottle, which comprises: the above described cartridge; a sealing unit for sealing the bottle by attaching the sealing sheet received from the cartridge to an opening of the bottle; and a transfer belt for transferring the bottle to be sealed to the sealing unit.

In one embodiment, the sealing apparatus may further comprises a suction nozzle for suctioning the sealing sheet from the cartridge to convey the sealing sheet to the sealing unit,

In one embodiment, the suction nozzle suctions a lower surface of the lowermost sealing sheet among the plurality of stacked sealing sheets to transfer it to a lower surface of the sealing unit, and the sealing unit is configured to align and attach the sealing sheet on the lower surface to the opening of the bottle to seal the bottle by high-frequency sealing.

### Effect of Invention

The diameter variable type cartridge according to the present invention is capable of adjusting the diameter according to the size of the sealing sheets by varying the distance among the plurality of guide bars that surround and support the sealing sheets, which makes it possible to accommodate the sealing sheets with various diameters using a single cartridge. Accordingly, it is not necessary to replace the cartridge, thereby eliminating the inconvenience of replacement operations and reducing the costs of device.

### BRIEF DESCRIPTION OF DRAWINGS

FIG. 1 is a schematic perspective view of the sealing apparatus according to one embodiment of the present invention.

FIG. 2 is a schematic top view of the sealing apparatus according to one embodiment of the present invention.

FIG. 3 is a schematic side view of the sealing apparatus according to one embodiment of the present invention.

FIG. 4 is a perspective view of the cartridge according to one embodiment of the present invention, viewed from the above.

FIG. 5 is a perspective view of the cartridge according to one embodiment of the present invention, viewed from the bottom.

FIG. 6 is a drawing explaining the operation of the cartridge according to one embodiment of the present invention.

FIG. 7 is a drawing explaining the lower constitution of the cartridge according to one embodiment of the present invention.

FIG. 8 is a drawing explaining the lower configuration of the cartridge according to an alternative example of the present invention.

FIG. 9 and FIG. 10 are drawings explaining the operations of the suction nozzle according to one embodiment of the present invention.

### DETAILED DESCRIPTION FOR CARRYING OUT THE INVENTION

The above-described objects, other objects characteristics and advantages of the present invention will be easily understood from the following preferred embodiments related to the attached drawings. However, the present invention is not limited to the embodiments explained herein, but can be implemented in other forms. The embodiments described hereinafter are exemplary ones provided in order to sufficiently convey the idea of the present invention to those skilled in the art.

In the specification of the present application, when a certain component is described as being coupled (or fastened or engaged) to another component, it means that the two components are coupled (or fastened or engaged) either directly or indirectly. Also, in the drawings, the length or thickness of the components may be exaggerated to effectively illustrate the technical contents.

In the specification of the present application, expressions, such as “upper,” “lower,” “left,” “right,” “front,” “rear,” etc. which are used to describe the positional relations among the components, do not indicate any absolute directions or positions, and these expressions may be relative ones used for convenience of explanation based on the drawings when explaining the present invention with reference to each drawing.

In the specification of the present application, singular forms may include plural forms as well, unless otherwise specified. In the specification of the present application, expressions such as “comprises,” configured to” and “is provided with” do not exclude the presence or addition of at least one component other than those mentioned using these expressions.

Hereinafter, the present invention will be explained in detail with reference to the drawings. When describing the following embodiments, various characteristic features are explained for the specific description and understanding of the invention, but the present invention is not limited thereto, and the technical idea of the present invention may be applicable to other specific configurations. In addition, in describing the present invention, commonly known components which are not highly related to the invention are not described to avoid any confusion in explaining the present invention.

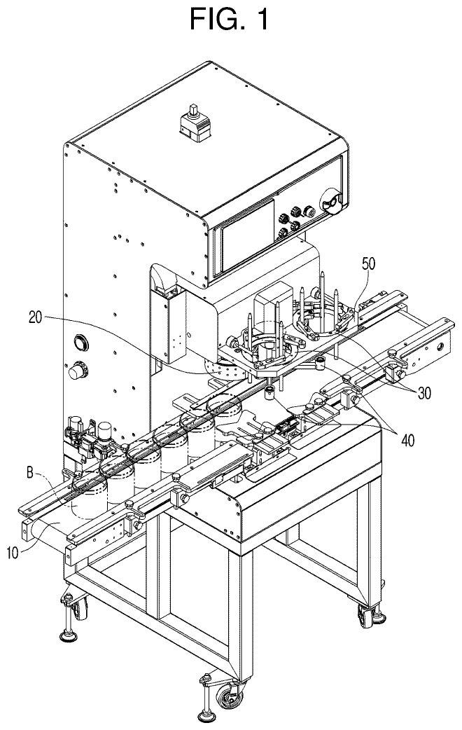

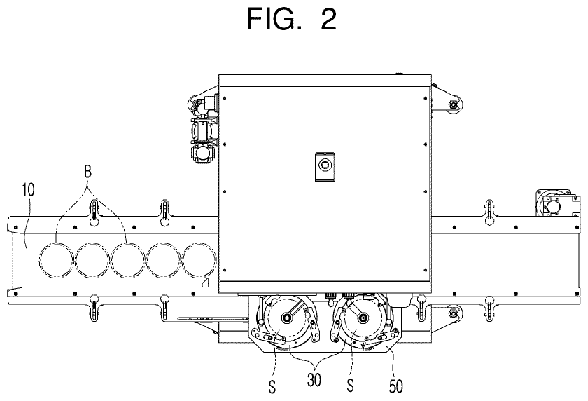

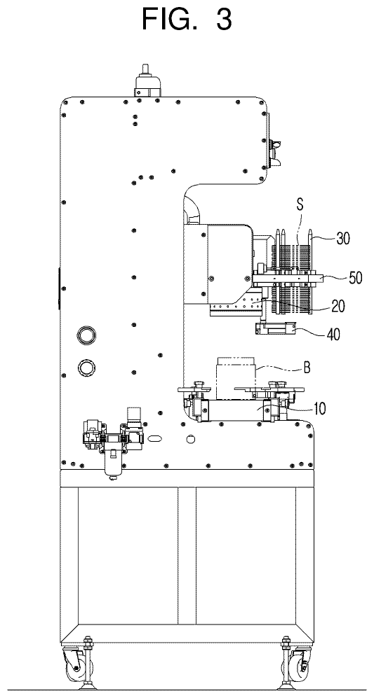

FIG. 1 is a schematic perspective view of the sealing apparatus according to one embodiment of the present invention; FIG. 2 is a schematic top view of the sealing apparatus; and FIG. 3 is a schematic side view of the sealing apparatus.

Referring to FIGS. 1 to 3, the sealing apparatus for sealing a bottle according to one embodiment may comprise a transfer belt (10), a sealing unit (20), a cartridge (30) and a suction nozzle (40).

The transfer belt (10) is a device, for example, a conveyor belt, which aligns bottles (B) to be sealed in a row and conveys them to the sealing unit (20). However, such configuration is merely exemplary, and various transfer means for conveying the bottle (B) may be applicable.

The sealing unit (20) is a device for closely attaching the sealing sheet (S) to the upper opening of the bottle (B) and then sealing it using high frequency. In one embodiment, the sealing unit (20) is arranged in the upper portion of the transfer belt (10), and when the bottle (B) to be sealed is positioned at the lower portion of the sealing unit (20), the sealing unit (20) may descend to closely attach the sealing sheet (S) to the opening of the bottle and seal it using high frequency.

For the high frequency sealing, the sealing unit (20) may comprise a suction unit and an induction coil. The suction unit is provided at the lower surface of the sealing unit (20), and may receive the sealing sheets (S) transferred by a suction nozzle (40) and hold them against the lower surface of the sealing unit (20) by suction. The induction coil may generate a high-frequency alternating magnetic field according to an induction sealing manner, to thereby attach and seal the sealing sheets (S) to the bottle (B). Components such as an air inlet, a vacuum pump, a high-frequency current generating unit, etc. are required for the operation of the suction unit and the induction coil, and a driving unit (for example, an air cylinder) is also required to enable the vertical movement of the sealing unit (20). However, it should be understood that these components are omitted since they are not highly related to the descriptions of the present invention.

In addition, it is explained, as one embodiment, that the sealing unit (20) performs sealing using a high-frequency sealing method, which, however, is merely exemplary, and of course, the sealing sheets may be attached to the opening of the bottle using other methods.

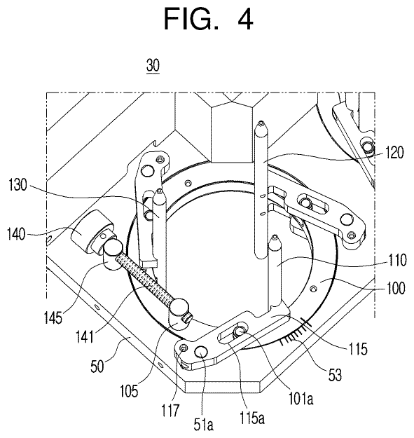

The cartridge (30) is an apparatus for accommodating a plurality of stacked sealing sheets (S), is supported by a support frame (50) of the sealing apparatus, and may be arranged adjacent to the sealing unit (20). The cartridge (30) consists of a plurality of guide bars (for example, 110, 120, 130 of FIG. 4) vertically arranged at predetermined intervals along the circumference of the plurality of stacked sealing sheets. In a preferred embodiment of the present invention, the plurality of guide bars (110, 120, 130) may simultaneously move in a direction either closer to or farther from the central axis of the cartridge (30) by a predetermined distance, and thus sealing sheets (S) of various sizes may be accommodated by adjusting the spacing among the guide bars (110, 120, 130).

The suction nozzle (40) is a member which suctions the lowermost sealing sheet among the stacked sealing sheets (S) in the cartridge (30) to convey it to the sealing unit (20). For the operation of the suction nozzle (40), additional driving units such as a vacuum pump, an air cylinder, etc. are included, but they are not illustrated in the drawings.

The sealing apparatus may comprise a plurality of sealing units (20), and accordingly, may include a plurality of cartridges (30) and suction nozzles (40). In the illustrated embodiment, the sealing apparatus is provided with two sealing units (20), two cartridges (30) and two suction nozzles (40), allowing it to seal two bottles (B) at once. However, it should be understood that such configuration is merely exemplary, and that the number of the sealing units (20), cartridges (30) and suction nozzles (40) may vary depending on the specific embodiments.

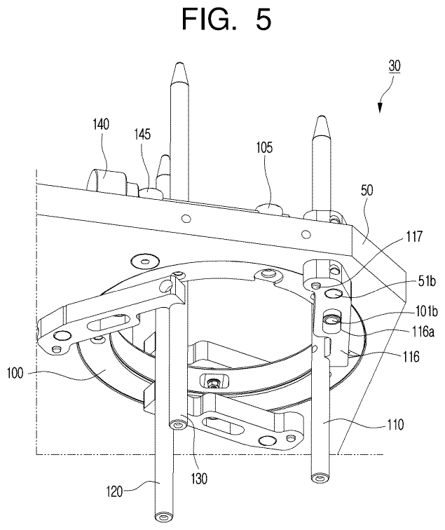

Herein, the cartridge (30) according to one embodiment of the present invention will be explained with reference to FIGS. 4 to 8. FIG. 4 is a perspective view of the cartridge according to one embodiment of the present invention, viewed from the above, and FIG. 5 is a perspective view of the cartridge (30) according to one embodiment of the present invention, viewed from the bottom. The sealing apparatus according to the above-described embodiment comprises two cartridges (30) having the same configuration, and the following explanation will focus only on one cartridge (30).

Referring to FIGS. 4 and 5, the cartridge (30) may be installed in the support frame (50) of the sealing apparatus, and may consist of a rotating ring (100), a plurality of guide bars (110, 120, 130), an adjusting knob (140), an adjusting shaft (141), upper and lower rotating members (115, 116), etc.

The rotating ring (100), which is an annular ring-shaped member, is installed rotatably on the support frame (50) of the sealing apparatus. That is, the rotating ring (100) is rotatable with respect to the support frame (50).

The plurality of guide bars (110, 120, 130) are vertically arranged and placed inside the rotating ring (100). Each of the guide bars (110, 120, 130) is rod-shaped, and the cross section thereof may have a polygonal shape such as circular, triangular, rectangular shapes, etc. In the drawings, three guide bars (110, 120, 130) are illustrated, which, however, are merely exemplary, and accordingly, the number of the guide bars may be two, four, five or another number according to specific embodiments.

In FIGS. 4 and 5, the members which support and move the first guide bar (110) are indicated with their reference numerals, and the following explanation will specifically focus only on the first guide bar (110). However, it should be understood that since the configurations which support and move each of the guide bars (110, 120, 130) are the same, the explanation for the first guide bar (110) will also apply to the second and third guide bars (120, 130).

The first guide bar (110) is coupled to the upper rotating member (115) and the lower rotating member (116), and thus is vertically supported. The upper rotating member (115) is a rod-shaped member and is horizontally arranged in the upper portion of the support frame (50). One end of the upper rotating member (115) is coupled to the first guide bar (110) to vertically support the first guide bar (110), and the other end is hinge-coupled to a protrusion unit (51a) protruding from the upper surface of the support frame (50) and thus can be rotated about the protrusion unit (51a).

The upper rotating member (115) is provided with a slot (115a) which extends vertically therethrough, and the protrusion unit (101a) protruding from the upper surface of the rotating ring (100) is inserted into the slot (115a) and thus can move within the slot (115a).

According to this configuration, referring to, for example, FIG. 4, when the rotating ring (100) rotates clockwise, the protrusion unit (101a) attached integrally to the rotating ring (100) also rotates to the left along with the rotating ring (100), allowing the protrusion unit (101a) to move within the slot (115a) of the upper rotating member (115). Accordingly, the upper rotating member (115) will move counterclockwise about the protrusion (51a) as the axis of rotation, and thus the first guide bar (110), as shown in FIG. 4, will move from a position close to the rotating ring (100) toward the central axis of the cartridge (30) (that is, the central axis of the rotating ring (100) or the central point of the virtual horizontal circle defined by the three guide bars (110, 120, 130)).

The lower rotating member (116) is a rod-shaped member having the same shape as the upper rotating member (115), and is arranged in the lower portion of the support frame (50). One end of the lower rotating member (116) is coupled to the first guide bar (110) to vertically support the first guide bar (110), and the other end is hinge-coupled to a protrusion unit (51b) protruding from the lower surface of the support frame (50) and thus can be rotated about the protrusion unit (51b). The lower rotating member (116) is provided with a slot (116a) which extends vertically therethrough, and the protrusion unit (101b) protruding from the upper surface of the rotating ring (100) is inserted into the slot (116a) and thus can move within the slot (116a).

Accordingly, when the rotating ring (100) rotates, the upper rotating member (115) and the lower rotating member (116) move integrally as one body, causing the first guide bar (110) to move in a direction closer to or farther from the central axis of the cartridge (30).

And the first to third guide bars (110, 120, 130), as illustrated in the drawings, are all coupled to the rotating ring (100) with the same configuration. Accordingly, as the rotating member (100) rotates clockwise or counterclockwise, the first to third guide bars (110, 120, 130) will simultaneously move in a direction either closer to or farther from the central axis, thereby allowing the diameter of the virtual circle surrounded by the first to third guide bars (110, 120, 130) to be variable.

The method of rotating the rotating ring (100) can be implemented in various forms, and in the illustrated embodiment, a configuration using the adjusting shaft (141) is shown. In this embodiment, the adjusting shaft (151) is supported by being inserted into the first shaft support unit (105) attached to the rotating ring (100) and the second shaft support unit (145) attached to the upper surface of the support frame (50). The first shaft support unit (105) is rotatably attached to the rotating ring (100) and has a through hole through which the adjusting shaft (141) can penetrate. And threads are formed on the outer circumferential surface of the adjusting shaft (141), and treads which engage therewith are formed on the surface of the through hole of the first shaft support unit (105).

The second shaft support unit (145) has a through hole through which the adjusting shaft (141) can penetrate, and the adjusting shaft (141) inserted into the through hole of the second shaft support unit (145) is supported rotatably with respect to the second shaft support unit (145). An adjusting knob (140) with a relatively larger diameter is attached to the end of the adjusting shaft (141) on the side closer to the second shaft support unit (145), and a user may rotate the adjusting shaft (141) by turning the adjusting knob (140).

However, in the alternative embodiment, the adjusting shaft (141) may be rotated automatically, not by manually, and in this case, a rotation driving means such as a driving motor, etc. may be connected directly or indirectly to one end of the adjusting shaft (141).

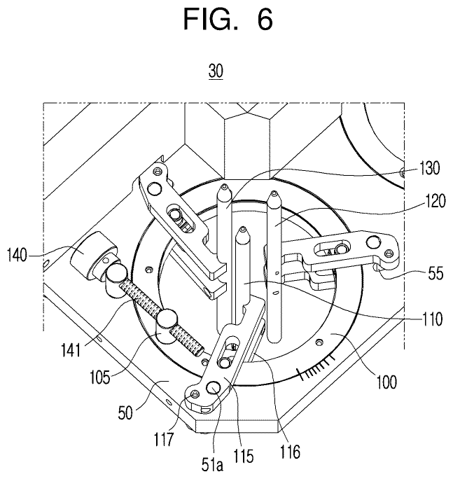

FIG. 6 is a drawing explaining the operation of the cartridge according to one embodiment of the present invention, and schematically illustrates a state where a user rotates the adjusting shaft (141) by turning the adjusting knob (140).

As can be seen from the comparison between FIG. 4 and FIG. 6, when the adjusting shaft (141) rotates, the second shaft support unit (145) is still fixed on the support frame (50), but the first shaft support unit (105) threadedly coupled to the adjusting shaft (141), moves in the direction closer to the second shaft support unit (145), and accordingly, the rotating ring (100) integrally attached to the first shaft support unit (105) also rotates counterclockwise.

When the rotating ring (100) rotates counterclockwise as above, the upper rotating member (115) and the lower rotating member (116) supporting the first guide bar (110) rotates about the protrusion units (51a, 51b) as its axis. Likewise, the second and third guide bars (120, 130) will move in the same manner, and thus the first to third guide bars (110, 120, 130), as illustrated in FIG. 6, will move in a direction closer to the central axis of the cartridge (30), resulting in a decrease in the diameter of the virtual circle surrounded by the guide bars (110, 120, 130).

Since the stacked sealing sheets (S) are accommodated in the space among the plurality of guide bars (110, 120, 130), the guide bars (110, 120, 130) may accommodate the sealing sheets (S) with a smaller diameter when they are close to one another, and may accommodate the sealing sheets (S) with a larger diameter when they are distant from one another. Thus, in the case of using the variable diameter type cartridge (30) according to the present invention, it is possible to handle the sealing sheets (S) with various diameters using a single cartridge (30), and accordingly, the cartridge does not have to be replaced according to the size of the sealing sheet (S).

Graduations (53) may be formed on the rotating ring (100) or the support frame (50) to help the user to easily determine to the degree to which the rotating ring (100) should be rotated according to the size of the sealing sheet (S). For example, it can be understood that when multiple graduations are marked on the support frame (50) according to the size of the sealing sheets and the graduation marked in the rotating ring (100) conforms to any one of the graduations (53) marked in the support frame (50), the cartridge (30) may accommodate the sealing sheet of the size conforming to that graduation.

In addition, in one embodiment, the cartridge (30) may further comprise a wrench bolt (117) which penetrates the upper rotating member (115) and the lower rotating member (116). The wrench bolt (117) is a bolt with a recessed hexagonal groove at the top for insertion of a hex wrench, and penetrates the slot (55) formed on the surface of the support frame (50) so as to simultaneously fasten the upper rotating member (115) and the lower rotating member (116).

The wrench bolt (117) firmly secures the upper rotating member (115) and the lower rotating member (116) to the support frame (50), serving to prevent the guide bars (110, 120, 130) from shaking. That is, in order to accommodate the sealing sheets with the diameter desired by the user by rotating the adjusting shaft (141), when the first to third guide bars (110, 120, 130) are moved, and the wrench bolt (117) is then tightened using a wrench, the upper rotating member (115) and the lower rotating member (116) will be closely attached to the support frame (50), which is interposed between them, respectively, while moving in directions bringing them closer to each other, enabling them to be firmly fastened to the support frame (50).

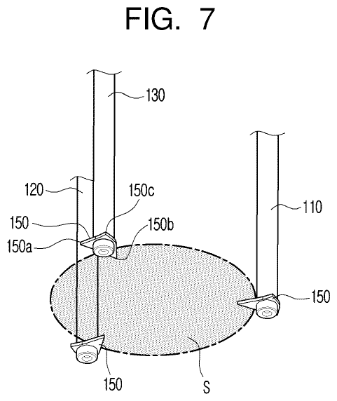

Meanwhile, the cartridge (30) should accommodate the sealing sheets (S) to be stacked in the space among the first to third guide bars (110, 120, 130) while supporting them, and thus the first to third guide bars (110, 120, 130) may comprise locking protrusions for supporting the sealing sheets (S) at their bottom, respectively. For example, in the embodiment of FIG. 7, each of the first to third guide bars (110, 120, 130) comprises a protrusion plate (150) having at least one horizontal locking protrusion at the bottom.

In the illustrated embodiment, each of the protrusion plates (150) may comprise a plurality of locking protrusions (150a, 150b, 150c) with different protrusion lengths in the horizontal direction. Also, the protrusion plate (150) may rotate about the guide bars (110, 120, 130) to which it is attached. Accordingly, for example, in the case of supporting the sealing sheet (S) with a larger diameter, the protrusion plate (150) should be rotated so that the first locking protrusion (150a) having the longest protrusion length faces the center of the sealing sheet (S) to support the sealing sheet; and in the case of supporting the sealing sheet (S) with a smaller diameter, the protrusion plate (150) should be rotated so that the second or third locking protrusion (150b, 150c) having a relatively short protrusion length faces the sealing sheet (S) to support the sealing sheet.

Since the locking protrusions should support the stacked sealing sheets (S) and simultaneously, the lowermost sealing sheet among the sealing sheets stacked in the cartridge (30) should be suctioned by the suction nozzle (40) and pulled out from beneath the protrusion plate (150), the locking protrusion should not be too small or large, compared to the diameter of the sealing sheet, but it should have an appropriate protrusion length. Accordingly, according to the present invention, when one of the locking protrusions (150a, 150b, 150c) is configured to face the center of the sealing sheets by rotating the protrusion plate (150) according to the size of the sealing sheet as described above, the most appropriate locking protrusion for the size of the corresponding sealing sheet can be defined to support the sealing sheet.

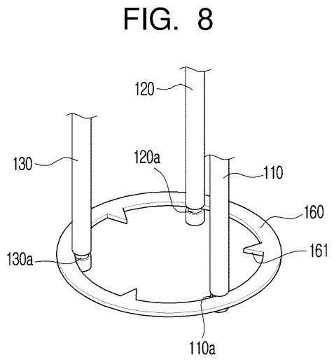

FIG. 8 shows the configuration of the bottom of cartridge according to an alternative embodiment, which uses the support ring (160) instead of the protrusion plate (150) of FIG. 7.

The support ring (160) is an annular ring-shaped member, which is provided with a plurality of inwardly protruding locking protrusions (161) to support the sealing sheets. The support ring (160) is installed such that each of the guide bars (110, 120, 130) is adjacent to the inner circumferential surface of the support ring (160). Each of the guide bars (110, 120, 130) is provided with grooves (110a, 120a, 130a) at its bottom to hang the support ring (160).

In order to install the support ring (160), the adjusting knob (140) is turned to move the guide bars (110, 120, 130) closer to one another to an extent that enable the guide bars (110, 120, 130) to pass through the interior space of the support ring (160), and then with the support ring (160) placed at the height of the grooves (110a, 120a, 130a), the adjusting knob (140) is turned to gradually spread the guide bars (110, 120, 130), allowing the inner circumferential surface of the support ring (160) to be inserted into the grooves (110a, 120a, 130a).

As described above, when the support rings (160) with various diameters are prepared in advance and sealing sheets to be stacked onto the cartridge (30) are determined, the support rings (160) having a diameter conforming to the size of the sealing sheet can be installed as described above.

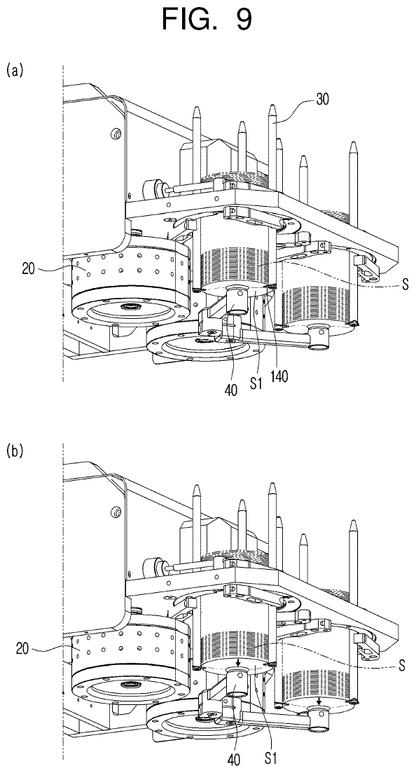

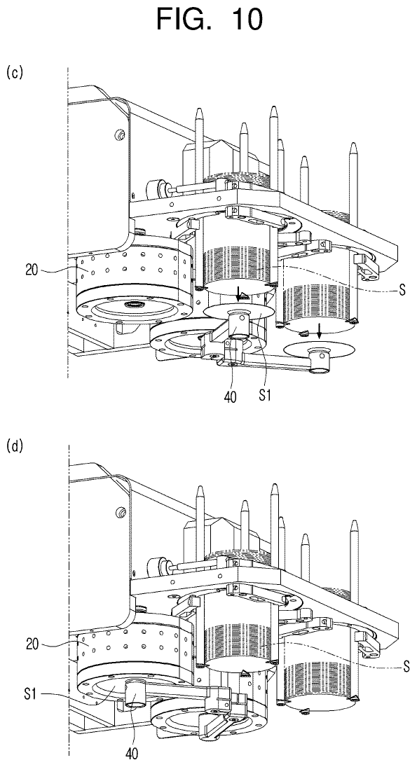

Herein, the operation in which the suction nozzle (40) pulls a sealing sheet from the cartridge (30) and conveys it to the sealing unit (20) will be explained with reference to FIGS. 9 and 10. Referring to FIG. 9(a), it is assumed that the sealing unit (20) and the cartridge (30) are arranged adjacent to each other, and that the suction nozzle (40) is operated under the cartridge (30).

First, the suction nozzle (40), as illustrated in FIG. 9(a), moves in a horizontal direction, is closely attached to the lowermost sealing sheet (S1) among a plurality of stacked sealing sheets on the cartridge (30), and then suctions the sealing sheet (S1). The suction nozzle (40), which has suctioned the lowermost sealing sheet (S1), should descend by a predetermined distance and then move toward the sealing unit (20). At this time, according to the present invention, the suction nozzle (40) does not descend by the full predetermined distance at once, but it moves downward by a small first distance at first, and then further descends by a remaining second distance.

That is, as illustrated in FIG. 9(b), it descends by a minute first distance, which creates a gap between the lowermost sealing sheet (S1) and the sealing sheet directly above it, allowing the inflow of air. If the suction nozzle (40) descends by the full descending distance at once, the sealing sheet right above the lowermost sealing sheet (S1) may also be pulled out by the friction with the lowermost sealing sheet (S1). However, if the suction nozzle (40), like in the present invention, descends by a minute first distance first to allow the gap and time between the lowermost sealing sheet (S) and the sealing sheet right above it for the air inflow, which reduces the friction between the two sealing sheets, allowing to suction and pull out only the lowermost sealing sheet (S1).

As described above, the suction nozzle (40) descends by the first distance, and after a predetermined pause, it further descends by the second distance as illustrated in FIG. 10(a), thereby descending by the predetermined distance as originally intended. At this time, the first distance for minutely descending may be, for example, 1 mm to 5 mm, and the pause time between the first distance movement and the second distance movement may range from 0.1 to 1 second; however, these are merely exemplary, and the first distance and the pause time may be defined according to specific embodiments of the present invention.

As then, the sealing sheet (S1) is conveyed to the lower part of the sealing unit (20) as illustrated in FIG. 10(b). The sealing unit (20) also comprises a suction nozzle at its bottom, the sealing sheet (S1) may be suctioned at the lower surface of the sealing unit (20) by this suction nozzle, and the suction nozzle (40) conveys the sealing sheet (S) to the lower surface of the sealing unit (20) by either reducing its suction force or stopping suction. The suction unit (40) then moves back to the cartridge (30). And the sealing unit (20) descends toward the bottle (B) when the bottle is positioned directly below it, closely attaches the sealing sheet (S1) to the opening of the bottle (B), and carries out high-frequency sealing.

As described above, various modifications and changes of the present invention can be made by a person having ordinary skill in the art to which the present invention pertains from the detailed description of the invention. Therefore, the scope of the present invention should not be limited to the above-described embodiments, but should be defined by the appended claims and their equivalents.

### EXPLANATION OF REFERENCE NUMERALS

10: transfer belt
20: sealing unit
30: cartridge
40: suction nozzle
50: support frame
100: rotating ring
110, 120, 130: guide bars
115: upper rotating member
116: lower rotating member
140: adjusting knob
141: adjusting shaft
150: protrusion plate
160: support ring

1. A cartridge that can be attached to a sealing apparatus for sealing a bottle and accommodates a plurality of stacked sealing sheets, comprising:
an annular-shaped rotating ring that can be rotatably installed in the sealing apparatus; and
a plurality of guide bars installed inside of the rotating ring and vertically arranged at a predetermined interval from each other along the circumference of the plurality of stacked sealing sheets,
wherein the plurality of guide bars are configured to move simultaneously closer to a center of the rotating ring or to move simultaneously away from the center.

2. The cartridge according to claim 1, wherein each of the plurality of guide bars comprises a protrusion plate having at least one horizontal locking protrusion at its bottom.

3. The cartridge according to claim 2, wherein the protrusion plate comprises a plurality of locking protrusions with different protrusion lengths in the horizontal direction.

4. A sealing apparatus for sealing a bottle, comprising:
the cartridge according to claim 1,
a sealing unit for sealing the bottle by attaching the sealing sheet received from the cartridge to an opening of the bottle; and
a transfer belt for transferring the bottle to be sealed to the sealing unit.

5. The sealing apparatus according to claim 4, further comprising a suction nozzle for suctioning the sealing sheet from the cartridge to convey the sealing sheet to the sealing unit,
wherein the suction nozzle suctions a lower surface of the lowermost sealing sheet among the plurality of stacked sealing sheets to transfer it to a lower surface of the sealing unit, and the sealing unit is configured to align and attach the sealing sheet on the lower surface to the opening of the bottle to seal the bottle by high-frequency sealing.
